(19) United States
(12) Patent Application Publication
(10) Pub. No.: US 2019/0122182 A1
(43) Pub. Date: Apr. 25, 2019

(54) Method and Apparatus for Transacting Real Estate

(71) Applicant: Bradley Joseph Trevino, McKinney, TX (US)

(72) Inventor: Bradley Joseph Trevino, McKinney, TX (US)

(21) Appl. No.: 16/110,160

(22) Filed: Aug. 23, 2018

Related U.S. Application Data
(60) Provisional application No. 62/574,829, filed on Oct. 20, 2017.

(51) Int. Cl. G06Q 10/10; G06Q 50/16

(52) U.S. Cl. CPC G06Q 10/1095; G06Q 30/06; G06Q 50/16

(57) ABSTRACT

A method and apparatus for transacting real estate consist that allows sellers of real estate to list their homes online and create customizable electronic calendars. It also allows buyers of real estate to access customized electronic calendars of sellers of real estate to schedule viewings of the real estate. The apparatus allows for automatic scheduling of multiple real estate listings using an algorithm to cross reference geographical location, seller's calendars, and buyer's preferred viewing times to automatically generate a schedule of viewings. Buyers receive a time-limited code to a seller's lockbox. The apparatus allows the buyer and seller of real estate to enter negotiations directly through the apparatus. The apparatus provides access to forms and real estate professionals to assist in the transaction process.

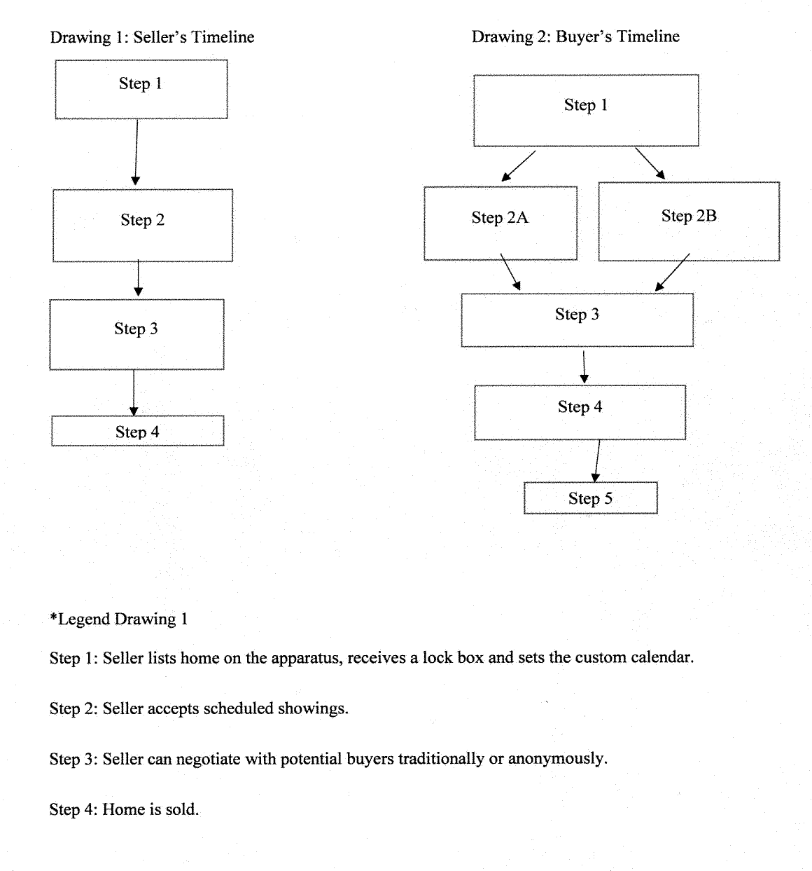

### BACKGROUND, FIELD, AND INTRODUCTION

The concept began as we were going through the process of both selling and buying a home. We have frustration with the inefficiency of the system realtors use to ask us to show the home and we wish we could see homes we find ourselves more quickly and without having to call our realtor.

Currently most realtors use a system called Centralized Showing System (CSS). CSS requires you give them set hours that remain constant every day that your house is available to be shown. There is little flexibility and zero customization. When a realtor contacts CSS they request a time they want to show the house. CSS sends us a text and asks us to reply yes or no or may offer one or two alternatives. If none of the times presented work, you are forced to respond “no” and the showing may or may not decide to try and reschedule. If you respond with an alternate time, the question shifts to the buyer whether it works or not. If the proposed time does not, the showing is not scheduled and may or may not ever happen again. It can be inefficient and potentially stops several showings from happening. If we could have communicated, anonymously or otherwise, with the other party we could have easily come to an agreed upon time. CSS does not allow for this.

As a buyer, a big frustration is having to wait days to go look at houses we want to see. With sites like Trulia and Zillow, it is us, the buyer, that finds all of the homes we would like to see. We then send that list to a realtor and they try to schedule as many of those homes as possible on a certain day. There are many times we wished we could have just booked a showing ourselves and ran over and looked at a place. There are times we would like to see one or two houses only and feel that the realtor wouldn't want to block part of their day for just a few homes. There are times we are driving around a neighborhood and see a house we would like to view. Wishing there was a way to immediately contact the owner and see if a showing right then was acceptable. Finally, even on days where we look at 8, 9, or 10 homes really all we need the realtor for is scheduling them. If we could just click the homes we want to see, input a timeframe, and get sent back a schedule, the realtor wouldn't be necessary.

Finally, total realtor fees when a home is sold is usually 6%. For a $400,000 house, $24,000 is paid to the realtors. Consumers are the ones finding the homes they want to see. They are the ones going through the loan process and making sure they can buy the home. Realtors schedule showings and help connect buyers and sellers. If there was a way to efficiently and safely connect buyers and sellers, it would eliminate the vast majority of work a realtor does. 6% would no longer be necessary. This would allow both parties more room to negotiate and reach a deal successfully.

### BRIEF SUMMARY OF THE INVENTION

In an embodiment, a goal is to streamline the process of being able to view homes and connect with parties in a transaction. Sellers are able to customize their preferences, while buyers are able to gain access to a sellers property by a system generated access code. The access code can be generated for single properties, one at a time, or can be generated using a unique algorithm that cross-references the sellers unique calendars and the buyers preferred viewing times with a mapping software. This will allow buyers to efficiently view the homes they selected in the time frame given. All parties will have met stringent security requirements, so the apparatus allows this process to take place without the expense or restraints of realtors.

### BRIEF DESCRIPTION OF THE DRAWINGS

The drawings depict the timeline for Buyer's and Seller's utilizing the Method and apparatus to transact real estate.

Drawing 1 depicts the Seller's timeline, including listing the home, creating a specialized/searchable calendar, and moving to close.

Drawing 2 depicts the Buyer's timeline including the search and scheduling functions as well as the scheduling/mapping functions. It also describes the timeline through closing.

### DETAILED DESCRIPTION OF THE INVENTION

An embodiment is a method of buying or selling real estate. For example, an embodiment can be a website that is a resource for buyers, sellers, and renters. As opposed to or in addition to a website, apps or other platforms or systems may be employed. In an embodiment, a goal is to streamline the process of being able to view homes and connect with parties in a transaction. Sellers can list their homes with our company which can get them on our site as well as the MLS and the other major home selling sites (HAR, Zillow, Trulia). In an embodiment, through our website, buyers can select homes they would like to view and schedule viewings. In an embodiment, sellers can customize calendars with times the home is available to be viewed (for example, every day can be different). When a buyer selects the home, the seller's calendar appears, and the buyer can pick when they would like to view. In an embodiment, prior to the scheduled viewing time the buyer receives a text message with a number code or a bar code for the key lock box. In most cases, this code will be valid only for the time Buyer scheduled. The buyer can also scan the code once leaving premises. Sellers and buyers can also communicate anonymously if they prefer to eliminate scheduling conflicts. They can also opt out of messaging and choose to block certain users at any point in time. This can allow buyers to schedule viewings without requiring a realtor to act as a middleman. Sellers and buyers can work through the site to secure times for showings. In an embodiment, sellers are authenticated when they list the house. Buyers can be authenticate, for example, by scanning a government issued ID and a second form of ID (e.g. major credit card, birth certificate, social security Card).

In an embodiment, the website can also allow buyers to schedule multiple showings. Buyers input any number of houses they would like to see and the hours they are wanting to view them (eg. 6 specific homes between 2-5 pm), and the program can generate a schedule that can have confirmed showing times in the most efficient way possible (e.g. geographically as well as coordinating with the seller's calendars). The schedule generated can contain a mapping feature that can allow one site for reviewing, scheduling, mapping, and viewing homes for buyers and renters. Lock box codes for each home can be sent via text to Buyers. In an embodiment, this code is valid only for the time Buyer/system scheduled. The buyer can also scan the code when leaving each premises.

Once a buyer has found a home he/she would like to purchase they can choose to enter into negotiations directly with the seller or to work with a professional at that point. The site can provide access to forms to make offers and counter offers. It can provide all of the documents needed to move from listing to closing. It can have partners for every aspect of a real estate transaction that are available should the parties decide they would like a professional involved. The parties can also have access to Escrow, Title, and any other professionals needed to close the transaction. The site can also have mortgage lenders, insurance brokers, inspectors, and appraisers as partners that the seller and buyer will have access to. In an embodiment, all of the foregoing can be accomplished through the website. The website can also allow sellers represented by a real estate agent access to its technology through an agreement with the real estate agent and/or broker.

### *LEGEND DRAWING 2

Step 1: Buyer views houses on our apparatus.

Step 2A: Seller's Calendar is accessed and buyer schedules viewing.

Step 2B: Buyer inputs date and timeframe for multiple homes into Apparatus. Apparatus generates optimized viewing

Step 3: Buyer meets security requirements and receives time-limited access to seller's lock box.

Step 4: Buyer can negotiate with potential buyers traditionally or anonymously.

Step 5: Home is sold.

I claim:

1. A method and apparatus for transacting real estate consisting of:
(a) An apparatus that allows sellers of real estate to list their homes online and create customizable electronic calendars.
(b) An apparatus that allows buyers of real estate to access customized electronic calendars of sellers of real estate to schedule viewings of the real estate
(c) An apparatus allowing for entry into locked real estate via text messaging and lock boxes
(d) An apparatus allowing for automatic scheduling of multiple real estate listings using an algorithm to cross reference geographical location, seller's calendars, and buyer's preferred viewing times to automatically generate a schedule of viewings.
(e) An apparatus to electronically map viewing schedules generated.
(f) An apparatus allowing the buyer and seller of real estate to enter into negotiations directly through the apparatus.
(g) An apparatus providing access to forms and real estate professionals to assist in the transaction process.
A method and apparatus for transacting real estate consisting of:
An apparatus that allows sellers of real estate to list their homes online and create customizable electronic calendars.
A method and apparatus for transacting real estate consisting of:
An apparatus that allows buyers real estate to access customized electronic calendars of sellers of real estate to schedule viewings of the real estate
A method and apparatus for transacting real estate consisting of:
An apparatus allowing for automatic scheduling of multiple real estate listings using an algorithm to cross reference geographical location, seller's calendars, and buyer's preferred viewing times to automatically generate a schedule of viewings.
